(19) United States
(12) Patent Application Publication
(10) Pub. No.: US 2021/0234401 A1
(43) Pub. Date: Jul. 29, 2021

(54) POWER TRANSMISSION COIL UNIT, POWER RECEIVING COIL UNIT, AND WIRELESS POWER TRANSMISSION SYSTEM

(71) Applicant: TDK CORPORATION, Tokyo (JP)

(72) Inventors: Masayuki KOBAYASHI, Tokyo (JP); Masayuki SUGASAWA, Tokyo (JP)

(73) Assignee: TDK CORPORATION, Tokyo (JP)

(21) Appl. No.: 17/152,243

(22) Filed: Jan. 19, 2021

(30) Foreign Application Priority Data
Jan. 24, 2020 (JP) 2020-009644

(51) Int. Cl. H02J 50/00; H02J 50/10

(52) U.S. Cl. CPC H02J 50/005; H02J 50/10

(57) ABSTRACT

A power transmission coil unit capable of inhibiting a foreign body made of metal remaining placed on a surface of a casing is provided. The power transmission coil unit includes: a power transmission coil; and a first casing housing the power transmission coil, wherein a first surface of the first casing is a surface positioned on a predetermined first direction side among surfaces of the first casing and is inclined with respect to a first base face of the first casing, and wherein the first base face is a face that is parallel to a face having a largest area among faces facing the power transmission coil side of a base part of the first casing, and is a face that is parallel to the first direction.

### BACKGROUND OF THE INVENTION

### Field of the Invention

The present disclosure relates to a power transmission coil unit, a power receiving coil unit, and a wireless power transmission system.

Priority is claimed on Japanese Patent Application No. 2020-009644, filed Jan. 24, 2020, the content of which is incorporated herein by reference.

### Description of Related Art

Technologies relating to wireless power transmission systems performing wireless power transmission through magnetic fields have been researched and developed. In description here, wireless power transmission is wireless transmission of electric power.

In relation to this, a wireless power transmission system that includes a power transmission coil unit and a power receiving coil unit and performs wireless power transmission from the power transmission coil unit to the power receiving coil unit in a direction parallel to a horizontal plane is known (see Patent Document 1). In the description, the horizontal plane is a virtual plane that is orthogonal to the direction of gravity.

### PATENT DOCUMENTS

[Patent Document 1] Japanese Unexamined Patent Application, First Publication No. 2019-054658

### SUMMARY OF THE INVENTION

Here, in the wireless power transmission system disclosed in Patent Document 1, an upper face of a casing of the power transmission coil unit is parallel to the horizontal plane. Similarly, an upper face of a casing of the power receiving coil unit of the wireless power transmission system is parallel to the horizontal plane. For this reason, in the wireless power transmission system, there are cases in which placement of a foreign body made of metal on at least one of such upper faces unintentionally occurs. In a case in which such a foreign body remains on at least one of such upper faces, the wireless power transmission system may cause the foreign body to generate heat in accordance with a magnetic field when performing wireless power transmission.

The present disclosure is in consideration of such situations, and an object thereof is to provide a power transmission coil unit, a power receiving coil unit, and a wireless power transmission system capable of inhibiting a foreign body made of metal remaining placed on a surface of a casing.

According to one aspect of the present disclosure, there is provided a power transmission coil unit includes: a power transmission coil; and a first casing housing the power transmission coil, wherein a first surface of the first casing is a surface positioned on a predetermined first direction side among surfaces of the first casing and is inclined with respect to a first base face of the first casing, and wherein the first base face is a face that is parallel to a face having a largest area among faces facing the power transmission coil side of a base part of the first casing, and is a face that is parallel to the first direction.

According to the present disclosure, a foreign body made of metal can be inhibited from remaining to be placed on a surface of a casing.

### BRIEF DESCRIPTION OF THE DRAWINGS

FIG. 1 is a diagram illustrating an example of the configuration of a wireless power transmission system 1.

FIG. 2 is a perspective view illustrating Specific Example 1 of the configuration of a power transmission-side casing BX1.

FIG. 3 is a side view of the power transmission-side casing BX1 illustrated in FIG. 2.

FIG. 4 is a side view illustrating Specific Example 2 of the configuration of the power transmission-side casing BX1.

FIG. 5 is a perspective view illustrating Specific Example 3 of the configuration of the power transmission-side casing BX1.

FIG. 6 is a side view of the power transmission-side casing BX1 illustrated in FIG. 5.

FIG. 7 is a perspective view illustrating Specific Example 4 of the configuration of the power transmission-side casing BX1.

FIG. 8 is a side view illustrating an example of the configuration of the power transmission-side casing BX1 in a case in which a housing part BX3 illustrated in FIG. 7 includes a guide part G1.

FIG. 9 is a perspective view illustrating Specific Example 5 of the configuration of the power transmission-side casing BX1.

FIG. 10 is a perspective view illustrating Specific Example 1 of the configuration of a power receiving-side casing BX2.

FIG. 11 is a side view of the power receiving-side casing BX2 illustrated in FIG. 10.

FIG. 12 is a perspective view illustrating Specific Example 2 of the configuration of the power receiving-side casing BX2.

### DETAILED DESCRIPTION OF THE INVENTION

### Embodiment

Hereinafter, embodiments of the present disclosure will be described with reference to the drawings. Hereinafter, for convenience of description, the direction of gravity will be referred to as a downward direction or simply downward in the description. In addition, hereinafter, for convenience of description, a direction opposite to the direction of gravity will be referred to as an upward direction or simply upward in the description.

### <Configuration of Wireless Power Transmission System>

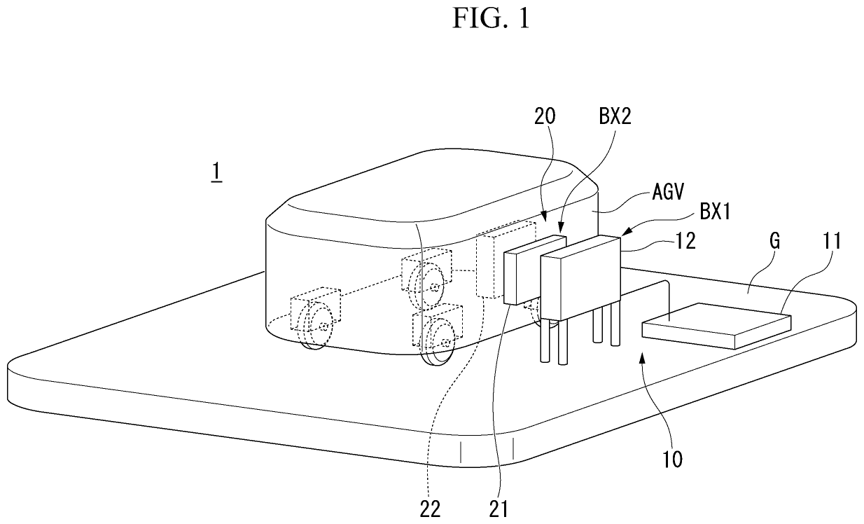

Hereinafter, the configuration of a wireless power transmission system 1 will be described with reference to FIG. 1. FIG. 1 is a diagram illustrating an example of the configuration of the wireless power transmission system 1.

The wireless power transmission system 1 includes a wireless power transmission device 10 and a wireless power receiving device 20.

The wireless power transmission device 10 includes a power transmission unit 11 and a power transmission coil unit 12. On the other hand, the wireless power receiving device 20 includes a power receiving coil unit 21 and a power receiving unit 22. The wireless power receiving device 20 can be connected to a load. Here, for example, the load that can be connected to the wireless power receiving device 20 is a resistive load. The resistive load has an equivalent resistance value that changes with respect to over time with a demand state (a storage state or a consumption state) of electric power. In the example illustrated in FIG. 1, a battery mounted in a mobile body is connected to the wireless power receiving device 20 as an example of the resistive load. The mobile body, for example, is an AGV (Automated Guided Vehicle). The mobile body may be any other device that is controlled using electricity instead of the AGV. The wireless power receiving device 20 may be configured to be connected to a motor mounted in a mobile body instead of the battery or may be configured to be connected to another load. In addition, the wireless power receiving device 20 may be configured to include a load.

The power transmission unit 11 is connected to the power transmission coil unit 12. In addition, the power transmission unit 11 is connected to a power supply that is separate from the power transmission unit 11. The power transmission unit 11 converts an AC (Alternating Current) voltage input from the power supply into a DC (Direct Current) voltage having a desired voltage value. The power transmission unit 11 converts the converted DC voltage into an AC voltage of a driving frequency. Then, the power transmission unit 11 supplies the AC voltage of the driving frequency to the power transmission coil unit 12. Here, for example, the power supply is an external commercial power supply or the like.

The power transmission unit 11, for example, includes an AC/DC converter, an inverter, and the like. Here, the inverter is composed of a switching circuit in which a plurality of switching elements are bridge-connected and the like. In addition, the power transmission unit 11 may be configured to include another circuit that converts an AC voltage into a DC voltage having a desired voltage value instead of the AC/DC converter. Another circuit may be a circuit combining a rectification smoothing circuit and a PFC (Power Factor Correction) circuit or a circuit combining the rectification smoothing circuit and a switching circuit. The rectification smoothing circuit is a circuit that converts an AC voltage into a DC voltage through rectification. The PFC circuit is a circuit that performs power factor improvement. The switching circuit is a switching converter or the like. In addition, the power transmission unit 11 may be configured to include another circuit that converts a DC voltage into an AC voltage instead of the inverter.

The power transmission coil unit 12 includes a power transmission coil L1 not illustrated in FIG. 1. The power transmission coil L1 is a coil that functions as an antenna for wireless power transmission. In other words, the power transmission coil L1 generates an AC magnetic field in accordance with an AC voltage supplied from the power transmission unit 11. In accordance with this, the power transmission coil unit 12 transmits electric power to the wireless power receiving device 20 through wireless power transmission performed through the power transmission coil L1.

In addition, the power transmission coil unit 12 includes a capacitor which is not illustrated in the drawings. The capacitor configures a power transmission-side resonance circuit together with the power transmission coil L1 in the power transmission coil unit 12.

The power transmission coil unit 12 may have either a configuration including a magnetic body or a configuration not including a magnetic body. The magnetic body is an object that increases magnetic coupling between a power receiving coil L2 to be described below and the power transmission coil L1. In a case in which the power transmission coil unit 12 includes the magnetic body, the power transmission coil L1 is disposed on the magnetic body with an insulator therebetween. For example, the insulator may be air, a member having an insulating property other than air, or a combination of air and the member described above. In addition, the power transmission coil unit 12 may be configured to include another object that increases magnetic coupling between the power receiving coil L2 and the power transmission coil L1 instead of the magnetic body or in addition to the magnetic body.

Furthermore, the power transmission coil unit 12 may have either a configuration including an electromagnetic shielding body or a configuration not including an electromagnetic shielding body. Here, the electromagnetic shielding body is an object that suppresses leakage of a magnetic field generated by the power transmission coil L1 to the outside. For example, the electromagnetic shielding body is a metal plate or the like.

Here, for example, the power transmission coil L1 is a coil made by winding a Litz wire in a spiral pattern. A Litz wire is a conductor formed from copper, aluminum, or the like. For this reason, the power transmission coil L1 has an opening. The power transmission coil L1 can be regarded to have a coil face. The coil face of the power transmission coil L1 is a virtual face having a thickness including a conductor wound as the power transmission coil L1 and the opening included in the power transmission coil L1. In the embodiment, for simplification of description, a case in which the coil face of the power transmission coil L1 is a flat face not having any distortion, unevenness, and the like will be described.

The power transmission coil L1 is disposed such that the coil face is orthogonal or almost orthogonal to the horizontal plane inside the casing of the power transmission coil unit 12. Hereinafter, for convenience of description, the casing will be referred to as a power transmission-side casing BX. In other words, the coil face of the power transmission coil L1 is orthogonal or almost orthogonal to the horizontal plane inside the power transmission-side casing BX1. In the embodiment, for simplification of description, a case in which there is no error in the arrangement, the assembly, and the like of the power transmission coil L1 inside the power transmission-side casing BX1, and the coil face of the power transmission coil L1 is completely orthogonal to the horizontal plane will be described.

Since the coil face of the power transmission coil L1 is orthogonal to the horizontal plane, in a case in which electric power is transmitted to the power receiving coil unit 21 through wireless power transmission, the power transmission coil L1 is installed such that the power transmission coil L1 faces the power receiving coil L2 included in the power receiving coil unit 21. In other words, in this case, the power transmission coil L1 faces the power receiving coil L2 included in the power receiving coil unit 21 in a direction parallel to the horizontal plane. In the example illustrated in FIG. 1, in this case, the power transmission coil L1 is installed on a ground surface G to face a face on which the power receiving coil unit 21 is mounted among faces of the mobile body. In addition, in this example, the power transmission coil unit 12 including the power transmission coil L1 is installed on the ground surface G together with the power transmission unit 11. Here, in this example, the power transmission unit 11 and the power transmission coil unit 12 are separate bodies. The power transmission unit 11 and the power transmission coil unit 12 may be integrally configured.

In the embodiment, a control circuit controlling the wireless power transmission device 10 controls wireless power transmission performed between the wireless power transmission device 10 and the wireless power receiving device 20. This control circuit may be any circuit as long as it is a circuit that can control the wireless power transmission. For this reason, in the embodiment, description of the control circuit that controls the wireless power transmission device 10 will be omitted.

The power receiving coil unit 21 includes a power receiving coil L2 not illustrated in FIG. 1. The power receiving coil L2 is a coil that functions as an antenna for wireless power transmission. In other words, the power receiving coil unit 21 receives electric power from the wireless power transmission device 10 through wireless power transmission performed through the power receiving coil L2.

The power receiving coil unit 21 includes a capacitor not illustrated in the drawing. The capacitor configures a power receiving-side resonance circuit together with the power receiving coil L2 in the power receiving coil unit 21.

In addition, the power receiving coil unit 21 may have a configuration including a magnetic body or a configuration not including a magnetic body. The magnetic body is an object that increases magnetic coupling between the power transmission coil L1 and the power receiving coil L2. In a case in which the power receiving coil unit 21 includes the magnetic body, the power receiving coil L2 is disposed on the magnetic body through an insulator. For example, the insulator may be air, a member having an insulating property other than the air, or a combination of air and the member described above. In addition, the power receiving coil unit 21 may be configured to include another object that increases magnetic coupling between the power transmission coil L and the power receiving coil L2 instead of the magnetic body or in addition to the magnetic body.

Furthermore, the power receiving coil unit 21 may have either a configuration including an electromagnetic shielding body or a configuration not including an electromagnetic shielding body. The electromagnetic shielding body is an object that suppresses leakage of a magnetic field generated by the power receiving coil L2 to the outside. For example, the electromagnetic shielding body is a metal plate or the like.

Here, for example, similar to the power transmission coil L1, the power receiving coil L2 is a coil made by winding the Litz wire described above in a spiral pattern. For this reason, the power receiving coil L2 includes an opening. The power receiving coil L2 can be regarded to have a coil face. The coil face of the power receiving coil L2 is a virtual face having a thickness including a conductor wound as the power receiving coil L2 and the opening included in the power receiving coil L2. In the embodiment, for simplification of description, a case in which the coil face of the power receiving coil L2 is a flat face not having any distortion, unevenness, and the like will be described.

The power receiving coil L2 is disposed such that the coil face is orthogonal or almost orthogonal to the horizontal plane inside the casing of the power receiving coil unit 21. Hereinafter, for convenience of description, the casing will be referred to as a power receiving-side casing BX2. In other words, the coil face of the power receiving coil L2 is orthogonal or almost orthogonal to the horizontal plane inside the power receiving-side casing BX2. In the embodiment, for simplification of description, a case in which there is no error in the arrangement, the assembly, and the like of the power receiving coil L2 inside the power receiving-side casing BX2, and the coil face of the power receiving coil L2 is completely orthogonal to the horizontal plane will be described.

Since the coil face of the power receiving coil L2 is orthogonal to the horizontal plane, in a case in which electric power is received from the power transmission coil unit 12 through wireless power transmission, the power receiving coil L2 is installed such that the power receiving coil L2 faces the power transmission coil L1 included in the power transmission coil unit 12. In other words, in this case, the power receiving coil L2 faces the power transmission coil L1 included in the power transmission coil unit 12 in the horizontal direction. In the example illustrated in FIG. 1, in this case, the power receiving coil L2 is installed on a side face of the mobile body such that the power receiving coil L2 faces the power transmission coil L1 of the power transmission coil unit 12 installed on the ground surface G. In addition, in this example, the power receiving coil unit 21 including the power receiving coil L2 is installed on the side face of the mobile body together with the power receiving unit 22. Here, in this example, the power receiving coil unit 21 and the power receiving unit 22 are separate bodies. The power receiving coil unit 21 and the power receiving unit 22 may be integrally configured.

The power receiving unit 22 is connected to the power receiving coil unit 21. In addition, in this embodiment, the power receiving unit 22 is connected to a load (the mobile body illustrated in FIG. 1). The power receiving unit 22 converts an AC voltage supplied from the power receiving coil L2 into a DC voltage through rectification. In the case of being connected to a load, the power receiving unit 22 supplies the converted DC voltage to the load. In the wireless power receiving device 20, the power receiving unit 22 may be configured to be connected to a load through a charging circuit.

For example, the power receiving unit 22 includes a rectification circuit, a smoothing circuit, and the like. Here, the rectification circuit is a circuit that rectifies an AC voltage. The smoothing circuit is a circuit that converts a voltage rectified by the rectification circuit into a DC voltage through smoothing. The power receiving unit 22 may be configured to include other circuits in addition to the rectification circuit and the smoothing circuit.

In the embodiment, a control circuit that controls the wireless power receiving device 20 controls wireless power transmission performed between the wireless power transmission device 10 and the wireless power receiving device 20. The control circuit may be any circuit as long as it is a circuit that can control the wireless power transmission. For this reason, in the embodiment, description of the control circuit controlling the wireless power receiving device 20 will be omitted.

Here, in a wireless power transmission system different from the wireless power transmission system 1, as described above, in a case in which wireless power transmission is performed, the power transmission coil of the power transmission coil unit and the power receiving coil of the power receiving coil unit face each other in a direction parallel to the horizontal plane. For this reason, in the wireless power transmission system, a magnetic field extends also in each of the direction of gravity and a direction opposite to the direction of gravity. In this the wireless power transmission system, there are cases in which placement of a foreign body made of metal on at least one of the upper face of the power transmission coil unit and the upper face of the power receiving coil unit unintentionally occurs. As a result, in a case in which such a foreign body remains on at least one of such upper faces, the wireless power transmission system may cause the foreign body to generate heat in accordance with a magnetic field when performing wireless power transmission.

In order to solve such a problem, in the wireless power transmission system 1, at least one of the power transmission-side casing BX1 and the power receiving-side casing BX2 has a configuration capable of inhibiting a foreign body made of metal remaining placed on a surface of a casing. Hereinafter, as an example, a case in which both the power transmission-side casing BX1 and the power receiving-side casing BX2 have configurations capable of inhibiting a foreign body made of metal remaining placed on the upper face will be described. Hereinafter, the configurations of the power transmission-side casing BX1 and the power receiving-side casing BX2 will be described in detail.

### Specific Example 1 of Configuration of Power Transmission-Side Casing

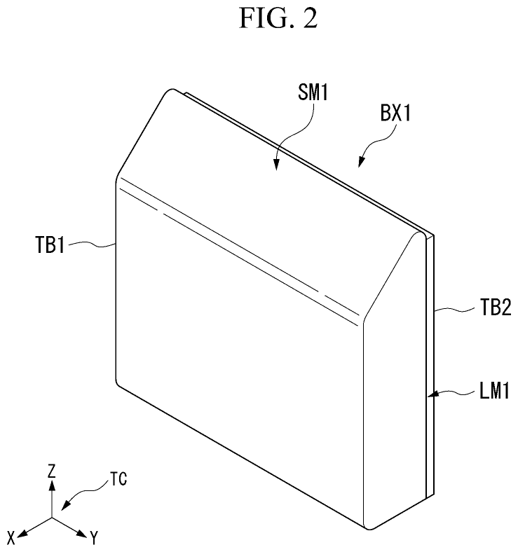

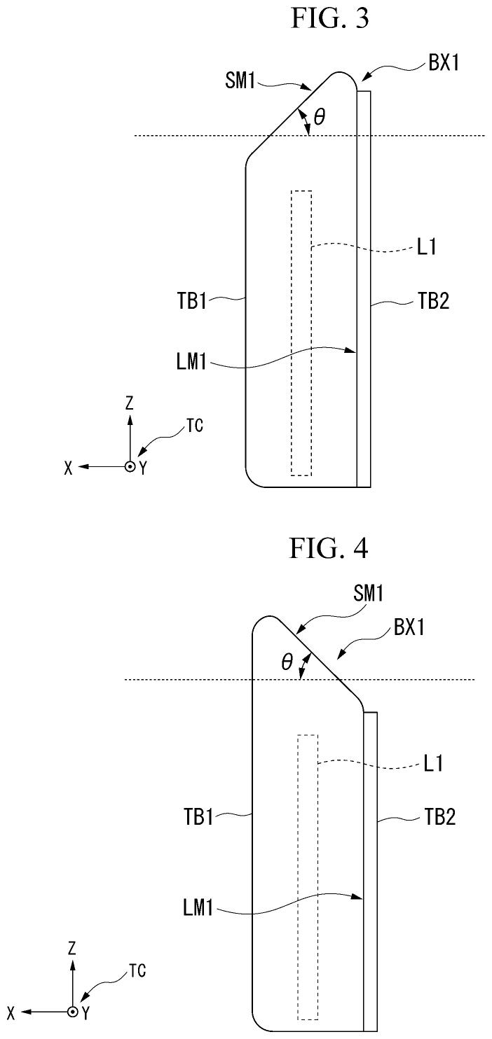

Hereinafter, Specific Example 1 of the configuration of the power transmission-side casing BX1 will be described. FIG. 2 is perspective view illustrating Specific Example 1 of the configuration of the power transmission-side casing BX1. FIG. 3 is a side view of the power transmission-side casing BX1 illustrated in FIG. 2.

Here, a three-dimensional coordinate system TC is a three-dimensional orthogonal coordinate system representing directions in a drawing in which the three-dimensional coordinate system TC is drawn. Hereinafter, for convenience of description, an X axis in the three-dimensional coordinate system TC will be simply referred to as an X axis in description. In addition, hereinafter, for convenience of description, a Y axis in the three-dimensional coordinate system TC will be simply referred to as a Y axis in description. Furthermore, hereinafter, for convenience of description, a Z axis in the three-dimensional coordinate system TC will be simply referred to as a Z axis in description. The X axis and the Y axis are coordinate axes that are parallel to the horizontal plane. The Z axis is a coordinate axis that is parallel to the direction of gravity in the drawing in which the three-dimensional coordinate system TC is drawn. In other words, a negative direction of the Z axis represents a downward direction, in other words, the direction of gravity. In addition, a positive direction of the Z axis represents an upward direction.

In the example illustrated in FIGS. 2 and 3, the power transmission coil L1 is arranged such that a coil face is parallel to a YZ plane inside the power transmission-side casing BX1. Here, a YZ plane is a virtual plane that is parallel to both the Y axis and the Z axis. In FIG. 2, for preventing the drawing from being complicated, illustration of the power transmission coil L1 is omitted. In FIG. 3, for preventing the drawing from being complicated, the power transmission coil L1 is represented as a rectangular area enclosed by dashed lines.

The power transmission-side casing BX1 includes a base part not illustrated in the drawing. The base part of the power transmission-side casing BX1 includes a first base face LM1. The first base face LM1 is a face having the largest area among faces facing the power transmission coil L1 side of the base part of the power transmission-side casing BX1. The first base face LM1 is a face that is parallel to a predetermined first direction. The first direction may be any direction. However, it is preferable that the first direction should be a direction opposite to a direction in which an object is attracted in accordance with an attracting force such as the force of gravity, an electromagnetic force, a negative pressure, or the like in a case in which the power transmission-side casing BX1 is installed using a predetermined installation method. Thus, hereinafter, as an example, a case in which the first direction coincides with the positive direction of the Z axis, in other words, a direction opposite to the direction of gravity will be described. Faces other than the first base face LM1 among faces of the base part of the power transmission-side casing BX1 that face the power transmission coil L1 side may be configured to have unevenness or may be configured to have no unevenness. In the example illustrated in FIGS. 2 and 3, the faces do not have unevenness.

Here, hereinafter, for convenience of description, a surface positioned on a first base face LM1 side from the power transmission coil L among two surfaces, which intersect a normal line of the first base face LM1, of the power transmission-side casing BX1 will be referred to as a rear surface of the power transmission-side casing BX1 in description. In addition, hereinafter, for convenience of description, a surface positioned on a power transmission coil L1 side from the first base face LM1 among two surfaces, which intersect the normal line of the first base face LM1, of the power transmission-side casing BX1 will be referred to as a front surface of the power transmission-side casing BX1 in description. In the example illustrated in FIGS. 2 and 3, the front surface and the rear surface of the power transmission-side casing BX1 are orthogonal to the normal line of the first base face LM1.

A first surface SM1 of the power transmission-side casing BX1 illustrated in FIGS. 2 and 3 is a surface positioned on the first direction side described above among surfaces of the power transmission-side casing BX1. Thus, in this embodiment, the first surface SM1 is an upper face of the power transmission-side casing BX1. The first surface SM1 is inclined with respect to the first base face LM1. In accordance with this, in a case in which a foreign body made of metal that has been attracted in a direction opposite to the first direction is placed on the first surface SM1 of the power transmission-side casing BX1, the power transmission coil unit 12 can inhibit the foreign body remaining placed on the first surface SM1.

The power transmission-side casing BX1 may be configured using a single member or may be configured using a plurality of members. In the example illustrated in FIGS. 2 and 3, the power transmission-side casing BX1 includes a power transmission-side first member TB1 and a power transmission-side second member TB2. In other words, in this example, the power transmission-side casing BX1 is composed of two members.

The power transmission-side second member TB2 is a member that configures the power transmission-side casing BX1 together with the power transmission-side first member TB1. The power transmission-side second member TB2 is a member that is assembled together with the power-transmission-side first member TB1. In addition, the power transmission-side second member TB2 includes the base part of the power transmission-side casing BX1. In the example illustrated in FIGS. 2 and 3, the power transmission-side second member TB2 is a member having a flat plate shape. In other words, in this example, the power transmission-side second member TB2 is a base plate of the power transmission coil unit 12. This base plate is a member made of metal and, for example, is composed of aluminum, copper, or the like.

The power transmission-side second member TB2 may be a member having another shape that can include the base part of the power transmission-side casing BX1 instead of the member having the flat plate shape. In addition, this base part may be configured to be included in the power transmission-side first member TB1 or may be configured to be included in both the power transmission-side first member TB1 and the power transmission-side second member TB2. The power transmission-side second member TB2 may be configured by a single member or may be configured by a plurality of members. Hereinafter, as an example, a case in which the power transmission-side second member TB2 is configured by a single member will be described.

The power transmission-side first member TB1 is a member that configures the power transmission-side casing BX1 together with the power transmission-side second member TB2. In addition, the power transmission-side first member TB1 is a member that is assembled together with the power transmission-side second member TB2. In the example illustrated in FIGS. 2 and 3, the power transmission-side first member TB1 is a member having a container shape that has a concave part. In this example, the power transmission-side first member TB1 includes the first surface SM1 described above. The concave part is shut by the power transmission-side second member TB2 in a case in which the power transmission-side second member TB2 is assembled together with the power transmission-side first member TB1. Various members disposed inside the power transmission coil unit 12 are housed inside a space enclosed by the concave part and the power transmission-side second member TB2. For example, the power transmission coil L1 is housed inside this space. Hereinafter, for convenience of description, this space will be referred to as a first space in description. In other words, the power transmission coil L1 is housed inside the first space between the power transmission-side first member TB1 and the power transmission-side second member TB2 in a case in which the power transmission-side second member TB2 is assembled together with the power transmission-side first member TB1.

The first base face LM1 described above can be said to be a face that faces the first space among faces included in the base part of the power transmission-side casing BX1. The first surface SM1 may be configured to be included in the power transmission-side second member TB2 or may be configured to be included in both the power transmission-side first member TB1 and the power transmission-side second member TB2. The power transmission-side first member TB1 may be configured by a single member or may be configured by a plurality of members. Hereinafter, as an example, a case in which the power transmission-side first member TB1 is configured by a single member will be described.

Here, in the example illustrated in FIGS. 2 and 3, as described above, the power transmission-side second member TB2 is a member having a flat plate shape. For this reason, in this example, the first surface SM1 is configured by the power transmission-side first member TB1. The first surface SM1 is inclined with respect to the first base face LM1. Unevenness and the like may be present on the first surface SM1. However, even when unevenness and the like are present on the first surface SM1, the first surface SM1 is inclined with respect to the first base face LM1 as a whole. In addition, the first surface SM1 is inclined in a direction (in this example, the direction of gravity) that is opposite to the first direction as the first surface SM1 becomes closer to the front surface of the power transmission-side casing BX1 from the rear surface of the power transmission-side casing BX1. More specifically, in this example, in a case in which the power transmission coil unit 12 is seen in the negative direction of the Y axis, a slope of a linear function representing a straight line connecting a highest position of the first surface SM1 and a lowest position of the first surface SM1 has a positive value. In accordance with this, even when a foreign body made of metal attracted in a direction opposite to the first direction is placed on the first surface SM1 of the power transmission-side casing BX1, there is a high possibility of the foreign body rolling down from the first surface SM1 in the direction. In other words, even in a case in which a foreign body made of metal attracted in a direction opposite to the first direction is placed on the first surface SM1 of the power transmission-side casing BX1, the power transmission coil unit 12 can inhibit the foreign body remaining placed on the first surface SM1. In addition, when the foreign body remains to be placed on the first surface SM1, there are cases in which the transmission efficiency of wireless power transmission is lowered. In other words, even in such cases, the power transmission coil unit 12 inhibits the foreign body remaining placed on the first surface SM1, and, as a result, a decrease in the transmission efficiency of the wireless power transmission can be inhibited. Here, in a case in which the power transmission coil unit 12 is seen in the negative direction of the Y axis, a highest position of the first surface SM1 is a position located on a most positive direction side of the Z axis among positions on the first surface SM1 in the case. In addition, in the case, a lowest position of the first surface SM1 is a position located on a most negative direction side of the Z axis among the positions on the first surface SM1 in the case.

In a case in which the power transmission coil unit 12 is seen in the negative direction of the Y axis, an angle of an acute angle formed by the first surface SM1 of the power transmission-side casing BX1 and the first base face LM1, for example, is equal to or larger than 5°. In this way, even in a case in which a foreign body made of metal attracted in the direction that is opposite to the first direction is placed on the first surface SM1 of the power transmission-side casing BX1, the possibility of the foreign body rolling down from the first surface SM1 in the direction becomes higher. In other words, even in the case, the power transmission coil unit 12 can inhibit the foreign body remaining placed on the first surface SM1 more reliably. Asa result, the power transmission coil unit 12 can inhibit a decrease in the transmission efficiency of wireless power transmission more reliably. In the case, an angle of an acute angle formed by the first surface SM1 of the power transmission-side casing BX1 and the first base face LM1 may be larger than 0° and smaller than 5°.

In the example illustrated in FIGS. 2 and 3, the power transmission-side second member TB2 that is a member having a flat plate shape has a limited thickness. However, a thickness of the power transmission-side second member TB2, in other words, a length of the power transmission-side second member TB2 in a direction parallel to the X axis is sufficiently shorter than a length of the first surface SM1 of the power transmission-side casing BX1 in the direction. From these, as illustrated in FIGS. 2 and 3, in a case in which the power transmission-side second member TB2 is a member having a flat plate shape, the surface of the power transmission-side second member TB2 on the first direction side can be regarded not to configure the first surface SM1 of the power transmission-side casing BX1. Here, for example, a length of the power transmission-side second member TB2 in the direction is shorter than the thickness of the coil face of the power transmission coil L. In addition, for example, the length of the power transmission-side second member TB2 in the direction is shorter than a length of a magnetic body included in the power transmission coil unit 12 in the direction. In the case of such lengths, the length of the power transmission-side second member TB2 in the direction can be regarded to be sufficiently shorter than the length of the first surface SM1 of the power transmission-side casing BX1 in the direction.

In the example illustrated in FIGS. 2 and 3, an end part on the first direction side among end parts included in the first surface SM1 of the power transmission-side casing BX1, in other words, an upper end part of the first surface SM1 has roundness. The upper end part of the first surface SM1 may be configured not to have roundness. In other words, the upper end part of the first surface SM1 may be configured to be sharp.

A value representing the surface roughness of the first surface SM1 of the power transmission-side casing BX1 is smaller than a value representing the surface roughness of a surface, which positioned on the first direction side, of the power transmission-side second member TB2. In accordance with this, even in a case in which a foreign body made of metal attracted in a direction opposite to the first direction is placed on the first surface SM1 of the power transmission-side casing BX1, the power transmission coil unit 12 can cause the foreign body to easily fall from the first surface SM1. Here, in the embodiment, a value representing the surface roughness of a certain face is an arithmetic mean roughness or the like. As a method for configuring the value representing the surface roughness of the first surface SM1 of the power transmission-side casing BX1 to be smaller than the value representing the surface roughness of a surface, which positioned on the first direction side, of the power transmission-side second member TB2, there is a method of forming the first surface SM1 using a smooth resin. In a case in which the method is employed, for example, the first surface SM1 is made of a polyacetal resin, a nylon resin, or the like.

As above, in Specific Example 1 of the configuration of the power transmission-side casing BX1, the first surface SM1 of the power transmission-side casing BX1 is inclined with respect to the first base face LM1, the first surface SM1 of the power transmission-side casing BX1 is inclined in a direction opposite to the first direction as the first surface SM1 becomes closer to the front surface of the power transmission-side casing BX1 from the rear surface of the power transmission-side casing BX1, and an angle of the acute angle formed by the first surface SM1 of the power transmission-side casing BX1 and the first base face LM1 is equal to or larger than 5°. In accordance with this, even in a case in which a foreign body made of metal attracted in the direction opposite to the first direction is placed on the first surface SM1 of the power transmission-side casing BX1, the power transmission coil unit 12 can inhibit the foreign body remaining placed on the first surface SM1. As a result, even in such a case, the power transmission coil unit 12 can inhibit a decrease in the transmission efficiency of the wireless power transmission.

### Specific Example 2 of Configuration of Power Transmission-Side Casing

Hereinafter, Specific Example 2 of the configuration of the power transmission-side casing BX1 will be described. FIG. 4 is side view illustrating Specific Example 2 of the configuration of the power transmission-side casing BX1.

Specific Example 2 of the configuration of the power transmission-side casing BX1 is a modified example of Specific Example 1 of the configuration of the power transmission-side casing BX1. More specifically, in this Specific Example 2, a slope of the inclination of the first surface SM1 of the power transmission-side casing BX1 is different from that of Specific Example 1. In this Specific Example 2, the configuration other than the slope is a configuration similar to that of Specific Example 1.

In Specific Example 2 of the configuration of the power transmission-side casing BX1, the first surface SM1 of the power transmission-side casing BX1 is inclined in a direction opposite to the first direction as the first surface SM1 becomes closer to the rear surface of the power transmission-side casing BX1 from the front surface of the power transmission-side casing BX1. In other words, in a case in which the power transmission coil unit 12 is seen in the negative direction of the Y axis, a slope of a linear function representing a straight line connecting a highest position of the first surface SM1 and a lowest position of the first surface SM1 has a negative value. In accordance with this, even in a case in which a foreign body made of metal attracted in a direction opposite to the first direction is placed on the first surface SM1 of the power transmission-side casing BX1, the power transmission coil unit 12 can inhibit the foreign body remaining placed on the first surface SM1. As a result, the power transmission coil unit 12 can inhibit a decrease in the transmission efficiency of the wireless power transmission even in such a case. In addition, in the case, the power transmission coil unit 12 can cause the foreign body to fall toward the rear surface side of the power transmission-side casing BX1. As a result, for example, even in the case, the power transmission coil unit 12 can inhibit the foreign body from being interposed between the power transmission coil unit 12 and the power receiving coil unit 21. For this reason, this Specific Example 2 is a more preferable configuration than Specific Example 1 of the power transmission-side casing BX.

### Specific Example 3 of Configuration of Power Transmission-Side Casing

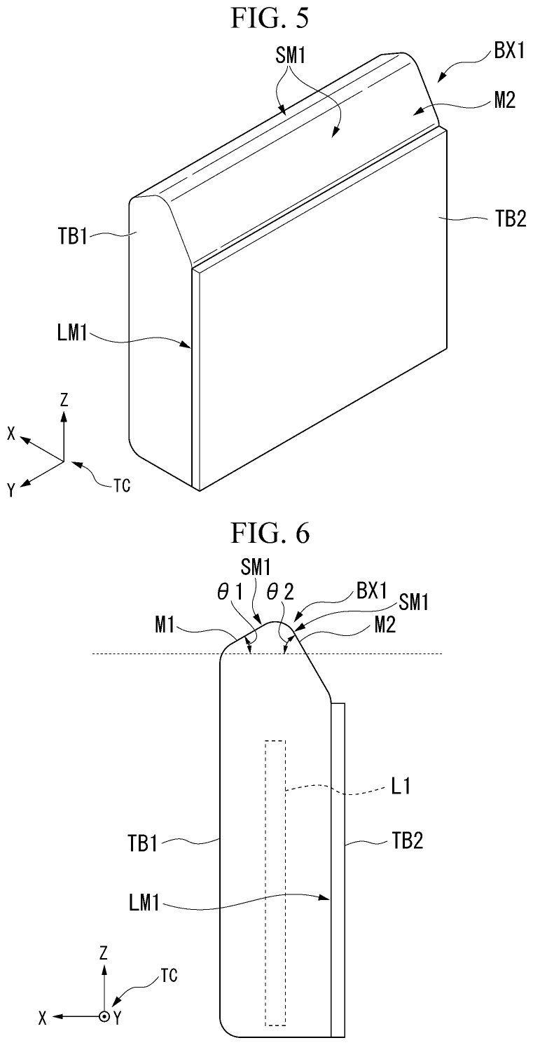

Hereinafter, Specific Example 3 of the configuration of the power transmission-side casing BX1 will be described. FIG. 5 is perspective view illustrating Specific Example 3 of the configuration of the power transmission-side casing BX1. FIG. 6 is a side view of the power transmission-side casing BX1 illustrated in FIG. 5.

Specific Example 3 of the configuration of the power transmission-side casing BXT is a modified example of Specific Example 1 of the configuration of the power transmission-side casing BX1 or Specific Example 2 of the configuration of the power transmission-side casing BX1. More specifically, in this Specific Example 3, a slope of the inclination of the first surface SM1 of the power transmission-side casing BX1 is different from that of Specific Example 1 or Specific Example 2. In this Specific Example 3, the configuration other than the slope is a configuration similar to that of Specific Example 1 or Specific Example 2.

In Specific Example 3 of the power transmission-side casing BX1, a first surface SM1 of the power transmission-side casing BX1 includes a first face M1 and a second face M2 positioned on a rear surface side of the power transmission-side casing BX1 from the first face M1.

The first face M1 is inclined with respect to the first base face LM1. The first face M1 is a face that is connected to the front surface of the power transmission-side casing BX1 and the second face M2. The first face M1 is inclined in the first direction as the first face M1 becomes closer to the rear surface of the power transmission-side casing BX1 from the front surface of the power transmission-side casing BX1. In other words, in a case in which the power transmission coil unit 12 is seen in the negative direction of the Y axis, a slope of a linear function representing a straight line connecting a highest position of the first face M1 and a lowest position of the first face M1 has a positive value. Here, in this case, the highest position of the first face M1 is a position located on the most positive direction side of the Z axis among positions on the first face M1 in the case. In addition, in the case, the lowest position of the first face M1 is a position located on the most negative direction side of the Z axis among positions on the first face M1 in the case.

The second face M2 is inclined with respect to a first base face LM1. The second face M2 is a face that is connected to the first face M1 and the rear surface of the power transmission-side casing BX1. The second face M2 is inclined in the first direction as the second face M2 becomes closer to the front surface of the power transmission-side casing BX1 from the rear surface of the power transmission-side casing BX1. In other words, in a case in which the power transmission coil unit 12 is seen in the negative direction of the Y axis, a slope of a linear function representing a straight line connecting a highest position of the second face M2 and a lowest position of the second face M2 has a negative value. Here, in this case, the highest position of the second face M2 is a position located on the most positive direction side of the Z axis among positions on the second face M2 in the case. In addition, in this case, the lowest position of the second face M2 is a position located on the most negative direction side of the Z axis among positions on the second face M2 in the case.

As above, in Specific Example 3 of the configuration of the power transmission-side casing BX1, the first surface SM1 of the power transmission-side casing BX1 has two faces of which ways of inclination with respect to the first base face LM1 are different from each other, in other words, the first face M1 and the second face M2. In accordance with this, the power transmission coil unit 12 can inhibit an increase in the size in the first direction (in other words, in the example illustrated in FIGS. 2 and 3, an increase in the height) and, even in a case in which a foreign body made of metal that has been attracted in a direction opposite to the first direction is placed on the first surface SM1 of the power transmission-side casing BX1, can inhibit the foreign body remaining placed on the first surface SM1 of the power transmission-side casing BX1.

An angle θ1 of an acute angle formed by the first face M1 and the first base face LM1 may be larger than an angle θ2 of an acute angle formed by the second face M2 and the first base face LM1. In accordance with this, the power transmission coil unit 12 can inhibit an increase in the size in an upward direction (in other words, in the example illustrated in FIGS. 2 and 3, an increase in the height) and, even in a case in which a foreign body made of metal that has been attracted in a direction opposite to the first direction is placed on the first surface SM1 of the power transmission-side casing BX1, can cause the foreign body to easily fall to the rear surface side of the power transmission-side casing BX1. The angle θ1 may be an angle that is equal to or larger than the angle θ2.

A boundary between the first face M1 and the second face M2 may be positioned nearer to the front surface of the power transmission-side casing BX1 than to the rear surface of the power transmission-side casing BX1. Also in this case, the power transmission coil unit 12 can inhibit an increase in the size in the first direction (in other words, in the example illustrated in FIGS. 2 and 3, an increase in the height) and, even in a case in which a foreign body made of metal that has been attracted in a direction opposite to the first direction is placed on the first surface SM1 of the power transmission-side casing BX1, can cause the foreign body to easily fall to the rear surface side of the power transmission-side casing BXL. The boundary may be positioned in the middle of the rear surface and the front surface or may be positioned nearer to the rear surface than to the front surface.

### Specific Example 4 of Configuration of Power Transmission-Side Casing

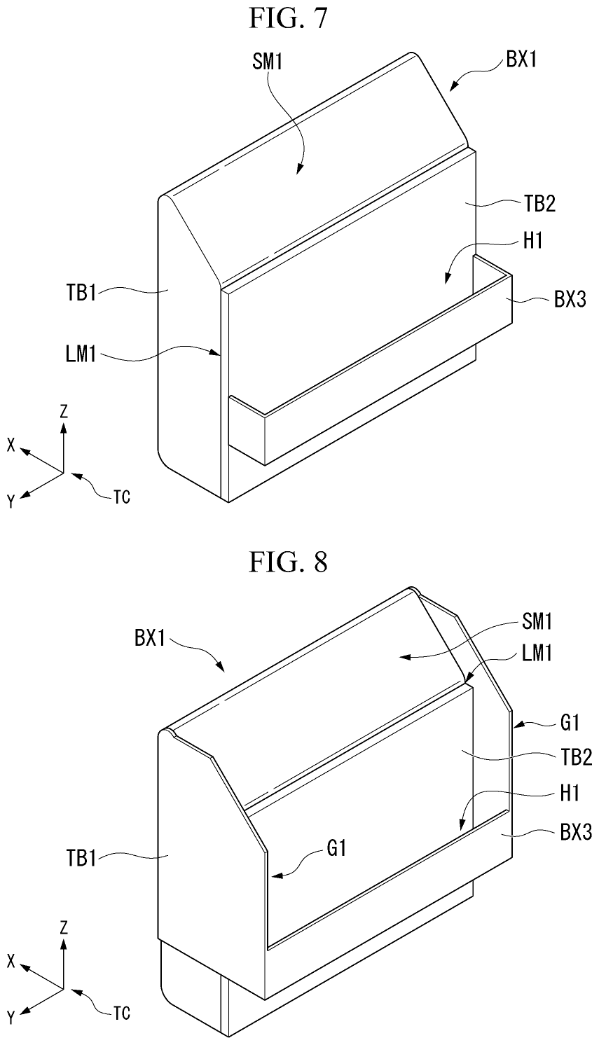

Hereinafter, Specific Example 4 of the configuration of the power transmission-side casing BX1 will be described. FIG. 7 is perspective view illustrating Specific Example 4 of the configuration of the power transmission-side casing BX1.

Specific Example 4 of the configuration of the power transmission-side casing BX1 is a modified example of Specific Example 2 of the configuration of the power transmission-side casing BX1 or Specific Example 3 of the configuration of the power transmission-side casing BX1. Hereinafter, as an example, this Specific Example 4 will be described as a modified example of Specific Example 2 of the configuration of the power transmission-side casing BX1.

In Specific Example 4 of the configuration of the power transmission-side casing BX1, a housing part BX3 is attached to the power transmission-side casing BX1. The housing part BX3 is a member that is included in the power transmission coil unit 12. For this reason, the power transmission-side casing BX1 may have a configuration including the housing part BX3 or may have a configuration not including the housing part BX3. The housing part BX3 may be integrally configured with the power transmission-side casing BX1 or may be configured as a body separate from the power transmission-side casing BX1. In the example illustrated in FIG. 7, the housing part BX3 that is a body separate from the power transmission-side casing BX1 is attached to the power transmission-side casing BX1.

The housing part BX3 is a container that houses a foreign body in a case in which the foreign body made of metal has fallen toward the rear surface side of the power transmission-side casing BX1 from the first surface SM1 of the power transmission-side casing BX1 in a case in which the first direction coincides with the upward direction. In other words, the housing part BX3 is disposed on the rear surface of the power transmission-side casing BX1. Here, the housing part BX3 has an opening H1. The opening H1, in a case in which the first direction coincides with the upward direction, is an entrance allowing the foreign body that has fallen toward the rear surface side to enter the inside of the housing part BX3. In the example illustrated in FIG. 7, in a case in which the first direction coincides with the upward direction, a lower face of the housing part BX3 is positioned on an upper side from a lower face of the power transmission-side casing BX1. In this way, the power transmission coil unit 12 can located the foreign body, which has fallen toward the rear surface side, on a side opposite to the power transmission coil L1 from the first base face LM1. For this reason, in a case in which the foreign body is located on a side opposite to the power transmission coil L1 from the first base face LM1, magnetic fluxes derived in accordance with wireless power transmission are blocked by the base portion of the power transmission-side casing BX1 and do not interlink with the foreign body. In other words, the power transmission coil unit 12 can reliably inhibit the foreign body from generating heat. A shape of the housing part BX3 may be any shape as long as it is a shape that can house a foreign body in a case in which the foreign body made of metal falls toward the rear surface side of the power transmission-side casing BX1 from the first surface SM1 of the power transmission-side casing BX1. For example, the shape of the housing part BX3 may be a plate shape.

By including such a housing part BX3 in the power transmission-side casing BX1, the power transmission coil unit 12, even in a case in which a foreign body made of metal that has been attracted in a direction opposite to the first direction falls from the first surface SM1 of the power transmission-side casing BX1, can inhibit the fallen foreign body from remaining to be scattered inside an area through which magnetic fluxes generated in accordance with wireless power transmission pass among areas on a face in which the power transmission coil unit 12 is installed. As a result, the power transmission coil unit 12 can inhibit the foreign body from generating heat and inhibit a decrease in the transmission efficiency of electric power according to the wireless power transmission in accordance with the presence of the foreign body. Here, for example, a situation in which the foreign body being in a scattered state inside the area causes a problem is a situation in which a distance between the face in which the power transmission coil unit 12 is installed and the power transmission coil unit 12 is short. In other words, for example, a situation in which the foreign body being in a scattered state inside the area causes a problem is a situation in which the power transmission coil unit 12 has a low center of gravity.

As illustrated in FIG. 8, the housing part BX3 may be configured to include a guide part G1 that guide a foreign body to the opening H1 together with the opening H1. In other words, the guide part G1 guides a foreign body to the housing part BX3. FIG. 8 is a side view illustrating an example of the configuration of the power transmission-side casing BX1 in a case in which the housing part BX3 illustrated in FIG. 7 includes the guide part G1. In accordance with this, the power transmission coil unit 12, even in a case in which a foreign body made of metal that has been attracted in a direction opposite to the first direction falls from the first surface SM1 of the power transmission-side casing BX1, can more reliably inhibit the fallen foreign body from being in a scattered state inside the area through which magnetic fluxes generated in accordance with wireless power transmission pass among areas on the face in which the power transmission coil unit 12 is installed.

### Specific Example 5 of Configuration of Power Transmission-Side Casing

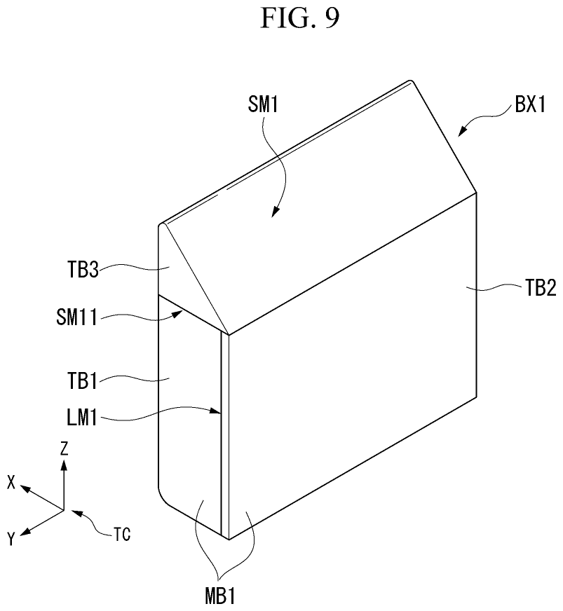

Hereinafter, Specific Example 5 of the configuration of the power transmission-side casing BX1 will be described. FIG. 9 is perspective view illustrating Specific Example 5 of the configuration of the power transmission-side casing BX1.

Specific Example 5 of the configuration of the power transmission-side casing BX1 is a modified example of Specific Examples 1 to 4 of the configuration of the power transmission-side casing BX1. Hereinafter, as an example, this Specific Example 5 will be described as a modified example of Specific Example 2 of the configuration of the power transmission-side casing BX1.

In Specific Example 5 of the configuration of the power transmission-side casing BX1, the power transmission-side casing BX1 includes a power transmission-side third member TB3 together with a power transmission-side first member TB1 and a power transmission-side second member TB2. In this Specific Example 5, a first surface SM1 of the power transmission-side casing BX1 is not configured by the power transmission-side first member TB1, and not configured by the power transmission-side second member TB2 too. In other words, in this Specific Example 5, the first surface SM1 may be configured by the power transmission-side third member TB3. In this Specific Example 5, the power transmission-side first member TB1 and the power transmission-side second member TB2 configure a power transmission-side main body member MB1. In other words, the power transmission-side third member TB3 is a member that is attached to the power transmission-side main body member MB1. The power transmission-side third member TB3 is an example of a power transmission-side inclination member.

In the example illustrated in FIG. 9, the power transmission-side second member TB2 is a member having a flat plate shape. In this example, the power transmission-side first member TB1 is a member having a container shape that has a concave part. In this example, the power transmission-side first member TB1 is a member that has a rectangular parallelopiped shape as a whole. For this reason, in this example, the power transmission-side first member TB1 and the power transmission-side second member TB2 configure a container having a rectangular parallelopiped shape as a whole. In other words, the power transmission-side main body member MB1 is a container that has a rectangular parallelopiped shape as a whole. The concave part is shut by the power transmission-side second member TB2 in a case in which the power transmission-side second member TB2 is assembled together with the power transmission-side first member TB1. Similar to the case of each of Specific Examples 1 to 4 of the configuration of the power transmission-side casing BX1, various members disposed inside the power transmission coil unit 12 are housed inside a first space enclosed by the concave part and the power transmission-side second member TB2. The power transmission-side main body member MB1 may be configured by a single member.

The power transmission-side third member TB3 is attached to the power transmission-side main body member MB1. More specifically, the power transmission-side third member TB3 is attached such that it covers a first surface SM11 of the power transmission-side main body member MB1. The first surface SM1l is a surface that is positioned on a first direction side among surfaces of the power transmission-side main body member MB1. For this reason, the power transmission-side third member TB3 configures a portion including the first surface SM1 of the power transmission-side casing BX1 among portions of the power transmission-side casing BX1. In other words, in Specific Example 5 of the configuration of the power transmission-side casing BX1, the first surface SM1 of the power transmission-side casing BX1 is configured by a member that is separate from the power transmission-side main body member MB1, in other words, the power transmission-side third member TB3. Also in this case, even in a case in which a foreign body made of metal that has been attracted in a direction opposite to the first direction is placed on the first surface SM1 of the power transmission-side casing BX1, the power transmission coil unit 12 can inhibit the foreign body remaining placed on the first surface SM1 of the power transmission-side casing BX1. As a result, also in such a case, the power transmission coil unit 12 can inhibit a decrease in the transmission efficiency of wireless power transmission.

In the example illustrated in FIG. 9, the power transmission-side third member TB3 is a member having a triangular prism shape extending in a direction parallel to the Y axis. When the power transmission coil unit 12 is seen in the negative direction of the Y axis, the shape of the power transmission-side third member TB3 is a right-angled triangle. Similar to Specific Example 2 of the configuration of the power transmission-side casing BX1, the first surface SM1 of the power transmission-side casing BX1 is inclined in a direction opposite to the first direction as the first surface SM1 becomes closer to the rear surface of the power transmission-side casing BX1 from the front surface of the power transmission-side casing BX1. The shape of the power transmission-side third member TB3 may be another shape according to the inclination of the first surface SM1.

### Specific Example 1 of Configuration of Power Receiving-Side Casing

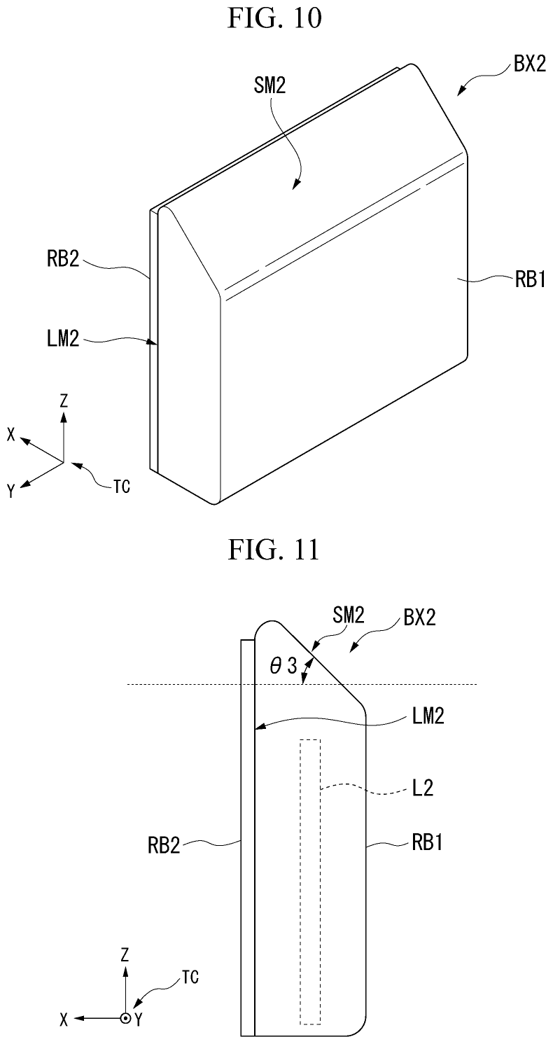

Hereinafter, Specific Example 1 of the configuration of the power receiving-side casing BX2 will be described. FIG. 10 is a perspective view illustrating Specific Example 1 of the configuration of the power receiving-side casing BX2. FIG. 11 is a side view of the power receiving-side casing BX2 illustrated in FIG. 10.

In the example illustrated in FIGS. 10 and 11, the power receiving coil L2 is arranged such that a coil face is parallel to the YZ plane inside the power receiving-side casing BX2. In FIG. 10, in order to prevent complications of the drawing, the power receiving coil L2 is omitted. In FIG. 11, in order to prevent complications, the power receiving coil L2 is represented as a rectangular area enclosed by dashed lines.

The power receiving-side casing BX2 includes a base part not illustrated in the drawing. The base part of the power receiving-side casing BX2 includes a second base face LM2. The second base face LM2 is a face having a largest area among faces facing the power receiving coil L2 side of a base part of the power receiving-side casing BX2 facing. In addition, the second base face LM2 is a face that is parallel to a predetermined second direction. The second direction may be any direction. However, it is preferable that the second direction should be a direction opposite to a direction in which an object is attracted in accordance with an attracting force such as the force of gravity, an electromagnetic force, a negative pressure, or the like in a case in which the power receiving-side casing BX2 is installed using a predetermined installation method. Thus, hereinafter, as an example, a case in which the second direction coincides with the positive direction of the Z axis, in other words, the first direction described above will be described. Faces other than the second base face LM2 among faces of the base part of the power receiving-side casing BX2 that face the power receiving coil L2 side may be configured to have unevenness or may be configured to have no unevenness. In the example illustrated in FIGS. 10 and 11, the faces do not have unevenness.

Here, hereinafter, for convenience of description, a surface positioned on a second base face LM2 side from the power receiving coil L2 among two surfaces, which intersect a normal line of the second base face LM2, of the power receiving-side casing BX2 will be referred to as a rear surface of the power receiving-side casing BX2 in description. In addition, hereinafter, for convenience of description, a surface positioned on a power receiving coil L2 side from the second base face LM2 among two surfaces, which intersect the normal line of the second base face LM2, of the power receiving-side casing BX2 will be referred to as a front surface of the power receiving-side casing BX2 in description. In the example illustrated in FIGS. 10 and 11, the front surface and the rear surface of the power receiving-side casing BX2 are orthogonal to the normal line of the second base face LM2.

A second surface SM2 of the power receiving-side casing BX2 illustrated in FIGS. 10 and 11 is a surface positioned on the second direction side described above among surfaces of the power receiving-side casing BX2. Thus, in this embodiment, the second surface SM2 is an upper face of the power receiving-side casing BX2. The second surface SM2 is inclined with respect to the second base face LM2. In accordance with this, in a case in which a foreign body made of metal that has been attracted in a direction opposite to the second direction is placed on the second surface SM2 of the power receiving-side casing BX2, the power receiving coil unit 21 can inhibit the foreign body remaining placed on the second surface SM2.

The power receiving-side casing BX2 may be configured using a single member or may be configured using a plurality of members. In the example illustrated in FIGS. 10 and 11, the power receiving-side casing BX2 includes a power receiving-side first member RB1 and a power receiving-side second member RB2. In other words, in this example, the power receiving-side casing BX2 is composed of two members.

The power receiving-side second member RB2 is a member that configures the power receiving-side casing BX2 together with the power receiving-side first member RB1. The power receiving-side second member RB2 is a member that is assembled together with the power receiving-side first member RB1. In addition, the power receiving-side second member RB2 includes the base part of the power receiving-side casing BX2. In the example illustrated in FIGS. 10 and 11, the power receiving-side second member RB2 is a member having a flat plate shape. In other words, in this example, the power receiving-side second member RB2 is a base plate of the power receiving coil unit 21. This base plate is a member made of metal and, for example, is composed of aluminum, copper, or the like.

The power receiving-side second member RB2 may be a member having another shape that can include the base part of the power receiving-side casing BX2 instead of the member having the flat plate shape. In addition, this base part may be configured to be included in the power receiving-side first member RB1 or may be configured to be included in both the power receiving-side first member RB1 and the power receiving-side second member RB2. The power receiving-side second member RB2 may be configured by a single member or may be configured by a plurality of members. Hereinafter, as an example, a case in which the power receiving-side second member RB2 is configured by a single member will be described.

The power receiving-side first member RB1 is a member that configures the power receiving-side casing BX2 together with the power receiving-side second member RB2. In addition, the power receiving-side first member RB1 is a member that is assembled together with the power receiving-side second member RB2. In the example illustrated in FIGS. 10 and 11, the power receiving-side first member RBI is a member having a container shape that has a concave part. In this example, the power receiving-side first member RB1 includes the second surface SM2 described above. The concave part is shut by the power receiving-side second member RB2 in a case in which the power receiving-side second member RB2 is assembled together with the power receiving-side first member RB1. Various members disposed inside the power receiving coil unit 21 are housed inside a space enclosed by the concave part and the power receiving-side second member RB2. For example, the power receiving coil L2 is housed inside this space. Hereinafter, for convenience of description, this space will be referred to as a second space in description. In other words, the power receiving coil L2 is housed inside the second space between the power receiving-side first member RB1 and the power receiving-side second member RB2 in a case in which the power receiving-side second member RB2 is assembled together with the power receiving-side first member RB1.

The second base face LM2 described above can be said to be a face that face the second space among faces included in the base part of the power receiving-side casing BX2. The second surface SM2 may be configured to be included in the power receiving-side second member RB2 or may be configured to be included in both the power receiving-side first member RB1 and the power receiving-side second member RB2. The power receiving-side first member RB1 may be configured by a single member or may be configured by a plurality of members. Hereinafter, as an example, a case in which the power receiving-side first member RBI is configured by a single member will be described.

Here, in the example illustrated in FIGS. 10 and 11, as described above, the power receiving-side second member RB2 is a member having a flat plate shape. For this reason, in this example, the second surface SM2 is configured by the power receiving-side first member RB1. The second surface SM2 is inclined with respect to the second base face LM2. Unevenness and the like may be present on the second surface SM2. However, even when unevenness and the like are present on the second surface SM2, the second surface SM2 is inclined with respect to the second base face LM2 as a whole. In addition, the second surface SM2 is inclined in a direction that is opposite to the second direction as the second surface SM2 becomes closer to the front surface of the power receiving-side casing BX2 from the rear surface of the power receiving-side casing BX2. More specifically, in this example, in a case in which the power receiving coil unit 21 is seen in the negative direction of the Y axis, a slope of a linear function representing a straight line connecting a highest position of the second surface SM2 and a lowest position of the second surface SM2 has a negative value. In accordance with this, even when a foreign body made of metal attracted in a direction opposite to the second direction is placed on the second surface SM2 of the power receiving-side casing BX2, there is a high possibility of the foreign body rolling down from the second surface SM2 in the direction. In other words, even in a case in which a foreign body made of metal attracted in a direction opposite to the first direction is placed on the second surface SM2 of the power receiving-side casing BX2, the power receiving coil unit 21 can inhibit the foreign body remaining placed on the second surface SM2. In addition, when the foreign body remains to be placed on the second surface SM2, there are cases in which the transmission efficiency of wireless power transmission is lowered. In other words, even in such cases, the power receiving coil unit 21 inhibits the foreign body remaining placed on the second surface SM2, and, as a result, a decrease in the transmission efficiency of the wireless power transmission can be inhibited. Here, in a case in which the power receiving coil unit 21 is seen in the negative direction of the Y axis, a highest position of the second surface SM2 is a position located on a most positive direction side of the Z axis among positions on the second surface SM2 in the case. In addition, in the case, a lowest position of the second surface SM2 is a position located on a most negative direction side of the Z axis among the positions on the second surface SM2 in the case.

In a case in which the power receiving coil unit 21 is seen in the negative direction of the Y axis, an angle of an acute angle formed by the second surface SM2 of the power receiving-side casing BX2 and the second base face LM2, for example, is equal to or larger than 5°. In this way, even in a case in which a foreign body made of metal attracted in the direction that is opposite to the second direction is placed on the second surface SM2 of the power receiving-side casing BX2, the possibility of the foreign body rolling down from the second surface SM2 in the direction becomes higher. In other words, even in the case, the power receiving coil unit 21 can inhibit the foreign body remaining placed on the second surface SM2 more reliably. As a result, the power receiving coil unit 21 can inhibit a decrease in the transmission efficiency of wireless power transmission more reliably. In the case, an angle of an acute angle formed by the second surface SM2 of the power receiving-side casing BX2 and the second base face LM2 may be larger than 0° and smaller than 5°.

In the example illustrated in FIGS. 10 and 11, the power receiving-side second member RB2 that is a member having a flat plate shape has a limited thickness. However, a thickness of the power receiving-side second member RB2, in other words, a length of the power receiving-side second member RB2 in a direction parallel to the X axis is sufficiently shorter than a length of the upper face of the power receiving-side casing BX2 in the direction. From these, as illustrated in FIGS. 10 and 11, in a case in which the power receiving-side second member RB2 is a member having a flat plate shape, the surface of the power receiving-side second member RB2 on the first direction side can be regarded not to configure the second surface SM2 of the power receiving-side casing BX2. Here, for example, a length of the power receiving-side second member RB2 in the direction is shorter than the thickness of the coil face of the power receiving coil L2. In addition, for example, the length of the power receiving-side second member RB2 in the direction is shorter than a length of a magnetic body included in the power receiving coil unit 21 in the direction. In the case of such lengths, the length of the power receiving-side second member RB2 in the direction can be regarded to be sufficiently shorter than the length of the second surface SM2 of the power receiving-side casing BX2 in the direction.

In the example illustrated in FIGS. 10 and 11, an end part on the second direction side among end parts included in the second surface SM2 of the power receiving-side casing BX2, in other words, an upper end part of the second surface SM2 has roundness. The upper end part of the second surface SM2 may be configured not to have roundness. In other words, the upper end part of the second surface SM2 may be configured to be sharp.

A value representing the surface roughness of the second surface SM2 of the power receiving-side casing BX2 is smaller than a value representing the surface roughness of a surface, which positioned on the second direction side, of the power receiving-side second member RB2. In accordance with this, even in a case in which a foreign body made of metal attracted in a direction opposite to the second direction is placed on the second surface SM2 of the power receiving-side casing BX2, the power receiving coil unit 21 can cause the foreign body to easily fall from the second surface SM2. As a method for configuring the value representing the surface roughness of the second surface SM2 of the power receiving-side casing BX2 to be smaller than the value representing the surface roughness of a surface, which positioned on the second direction side, of the power receiving-side second member RB2, there is a method of forming the second surface SM2 using a smooth resin. In a case in which the method is employed, for example, the second surface SM2 is made of a polyacetal resin, a nylon resin, or the like.

As above, in Specific Example 1 of the configuration of the power receiving-side casing BX2, the second surface SM2 of the power receiving-side casing BX2 is inclined with respect to the second base face LM2, the second surface SM2 of the power receiving-side casing BX2 is inclined in a direction opposite to the second direction as the second surface SM2 becomes closer to the front surface of the power receiving-side casing BX2 from the rear surface of the power receiving-side casing BX2, and an angle of the acute angle formed by the second surface SM2 of the power receiving-side casing BX2 and the second base face LM2 is equal to or larger than 5°. In accordance with this, even in a case in which a foreign body made of metal attracted in the direction opposite to the second direction is placed on the second surface SM2 of the power receiving-side casing BX2, the power receiving coil unit 21 can inhibit the foreign body remaining placed on the second surface SM2. As a result, even in such a case, the power receiving coil unit 21 can inhibit a decrease in the transmission efficiency of the wireless power transmission.

In addition, the second surface SM2 of the power receiving-side casing BX2 is inclined in a direction opposite to the second direction as the second surface SM2 becomes closer to the front surface of the power receiving-side casing BX2 from the rear surface of the power receiving-side casing BX2. In accordance with this, even in a case in which a foreign body made of metal that has been attracted in a direction opposite to the second direction is placed on the second surface SM2 of the power receiving-side casing BX2, the power receiving coil unit 21 can cause the foreign body to fall to the front surface side of the power receiving-side casing BX2. As a result, for example, even in the case, the power receiving coil unit 21 can inhibit the foreign body that has fallen from the second surface SM2 from being interposed between the mobile body and the power receiving coil unit 21.

### Specific Example 2 of Configuration of Power Receiving-Side Casing

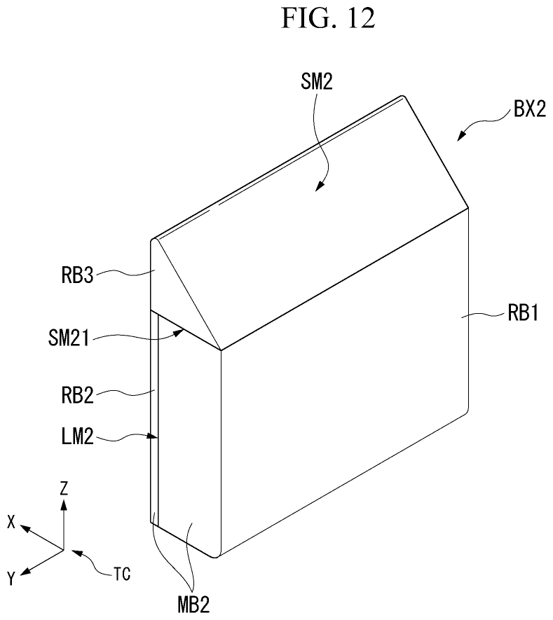

Hereinafter, Specific Example 2 of the power receiving-side casing BX2 will be described. FIG. 12 is perspective view illustrating Specific Example 2 of the configuration of the power receiving-side casing BX2.

Specific Example 2 of the configuration of the power receiving-side casing BX2 is a modified example of Specific Example 1 of the configuration of the power receiving-side casing BX2.

In Specific Example 2 of the configuration of the power receiving-side casing BX2, the power receiving-side casing BX2 includes a power receiving-side third member RB3 together with a power receiving-side first member RB1 and a power receiving-side second member RB2. In this Specific Example 2, a second surface SM2 of the power receiving-side casing BX2 is not configured by none of the power receiving-side first member RB1, and not configured by the power receiving-side second member RB2 too. In other words, in this Specific Example 2, the second surface SM2 is configured by the power receiving-side third member RB3. In this Specific Example 2, the power receiving-side first member RB1 and the power receiving-side second member RB2 configure a power receiving-side main body member MB2. In other words, the power receiving-side third member RB3 is a member that is attached to the power receiving-side main body member MB2. The power receiving-side third member RB3 is an example of a power receiving-side inclination member.

In the example illustrated in FIG. 12, the power receiving-side second member RB2 is a member having a flat plate shape. In this example, the power receiving-side first member RB1 is a member having a container shape that has a concave part. In this example, the power receiving-side first member RB1 is a member that has a rectangular parallelopiped shape as a whole. For this reason, in this example, the power receiving-side first member RB1 and the power receiving-side second member RB2 configure a container having a rectangular parallelopiped shape as a whole. In other words, the power receiving-side main body member MB2 is a container that has a rectangular parallelopiped shape as a whole. The concave part is shut by the power receiving-side second member RB2 in a case in which the power receiving-side second member RB2 is assembled together with the power receiving-side first member RB1. Similar to the case of Specific Example 1 of the configuration of the power receiving-side casing BX2, various members disposed inside the power receiving coil unit 21 are housed inside a second space enclosed by the concave part and the power receiving-side second member RB2. The power receiving-side main body member MB2 may be configured by a single member.

The power receiving-side third member RB3 is attached to the power receiving-side main body member MB2. More specifically, the power receiving-side third member RB3 is attached such that it covers a second surface SM21 of the power receiving-side main body member MB2. The second surface SM21 is a surface that is positioned on a second direction side among surfaces of the power receiving-side main body member MB2. For this reason, the power receiving-side third member RB3 configures a portion including the second surface SM2 of the power receiving-side casing BX2 among portions of the power receiving-side casing BX2. In other words, in Specific Example 2 of the configuration of the power receiving-side casing BX2, the second surface SM2 of the power receiving-side casing BX2 is configured by a member that is separate from the power receiving-side main body member MB2, in other words, the power receiving-side third member RB3. Also in this case, even in a case in which a foreign body made of metal that has been attracted in a direction opposite to the second direction is placed on the second surface SM2 of the power receiving-side casing BX2, the power receiving coil unit 21 can inhibit the foreign body remaining placed on the second surface SM2 of the power receiving-side casing BX2. As a result, also in such a case, the power receiving coil unit 21 can inhibit a decrease in the transmission efficiency of wireless power transmission.

In the example illustrated in FIG. 12, the power receiving-side third member RB3 is a member having a triangular prism shape extending in a direction parallel to the Y axis. When the power receiving coil unit 21 is seen in the negative direction of the Y axis, the shape of the power receiving-side third member RB3 is a right-angled triangle. Similar to Specific Example 1 of the configuration of the power receiving-side casing BX2, the second surface SM2 of the power receiving-side casing BX2 is inclined in a direction opposite to the second direction as the second surface SM2 becomes closer to the front surface of the power receiving-side casing BX2 from the rear surface of the power receiving-side casing BX2. The shape of the power receiving-side third member RB3 may be another shape according to the inclination of the second surface SM2.

In the wireless power transmission system 1, in a case in which both the power transmission coil unit 12 and the power receiving coil unit 21 have configurations capable of inhibiting a foreign body made of metal remaining placed on the upper face of the casing, any one of Specific Examples 1 to 5 of the configuration of the power transmission-side casing BX1 may be employed as the configuration of the power transmission-side casing BX1. In addition, in the wireless power transmission system 1, in this case, any one of Specific Examples 1 and 2 of the configuration of the power receiving-side casing BX2 may be employed as the configuration of the power receiving-side casing BX2.

As described above, a power transmission coil unit according to an embodiment (in the example described above, the power transmission coil unit 12) includes: a power transmission coil (in the example described above, the power transmission coil L1); and a first casing housing the power transmission coil (in the example described above, the power transmission-side casing BX1), wherein a first surface of the first casing (in the example described above, the first surface SM1) is a surface positioned on a predetermined first direction (in the example described above, a direction opposite to the direction of gravity, the positive direction of the Z axis, or the like) side among surfaces of the first casing and is inclined with respect to a first base face of the first casing (the first base face LM1), and wherein the first base face is a face that is parallel to a face having a largest area among faces facing the power transmission coil side of a base part of the first casing, and is a face that is parallel to the first direction. In accordance with this, the power transmission coil unit can inhibit a foreign body that generates heats in accordance with a magnetic field from being placed on an upper face of the casing.

In addition, in the power transmission coil unit, a configuration in which the first casing includes a power transmission-side first member (in the example described above, the power transmission-side first member TB1) and a power transmission-side second member (in the example described above, the power transmission-side second member TB2), and the power transmission-side second member includes the base part of the first casing may be used.

In addition, in the power transmission coil unit, a configuration in which the power transmission-side first member and the power transmission-side second member are members that are separate from each other, the power transmission-side first member includes the first surface, and a value representing a surface roughness of the first surface is smaller than a value representing a surface roughness of a surface on the first direction side of the power transmission-side second member may be used.

In addition, there is provided a power transmission coil unit includes: a power transmission coil; and a first casing including a power transmission-side main body member (in the example described above, the power transmission-side main body member MB1) that houses the power transmission coil and a power transmission-side inclination member (in the example described above, the power transmission-side third member TB3) that is attached to the power transmission-side main body member, wherein the power transmission-side inclination member includes a first surface of the first casing, wherein the first surface is a surface positioned on a predetermined first direction side among surfaces of the first casing and is inclined with respect to a first base face of the first casing, and wherein the first base face is a face that is parallel to a face having a largest area among faces facing the power transmission coil side of a base part of the first casing, and is a face that is parallel to the first direction. In accordance with this, the power transmission coil unit can inhibit a foreign body that generates heats in accordance with a magnetic field from being placed on an upper face of the casing.

In addition, in the power transmission coil unit, a configuration in which an angle of an acute angle formed by the first surface and the first base face is equal to or larger than 5° may be used.

In addition, in the power transmission coil unit, a configuration in which the first surface is inclined in a direction opposite to the first direction as the first surface becomes closer to a front surface of the first casing from a rear surface of the first casing, the rear surface of the first casing is a surface that is positioned on a first base face side from the power transmission coil among two surfaces, which intersect a normal line of the first base face, of the first casing, and the front surface of the first casing is a surface that is positioned on a power transmission coil side from the first base face among the two surfaces, which intersect the normal line of the first base face, of the first casing may be used.

In addition, in the power transmission coil unit, a configuration in which the first surface is inclined in a direction opposite to the first direction as the first surface becomes closer to a rear surface of the first casing from a front surface of the first casing, the rear surface of the first casing is a surface that is positioned on a first base face side from the power transmission coil among two surfaces, which intersect a normal line of the first base face, of the first casing, and the front surface of the first casing is a surface that is positioned on a power transmission coil side from the first base face among the two surfaces, which intersect a normal line of the first base face, of the first casing may be used.

In addition, in the power transmission coil unit, a configuration in which the first surface includes a first face (in the example described above, the first face M1) and a second face (in the example described above, the second face M2) that is positioned on a rear surface side of the first casing from the first face, the first face is inclined with respect to the first base face and is inclined in the first direction as the first face becomes closer to the rear surface of the first casing from the front surface of the first casing, the second face is inclined with respect to the first base face and is inclined in the first direction as the second face becomes closer to the front surface of the first casing from the rear surface of the first casing, the rear surface of the first casing is a surface positioned on a first base face side from the power transmission coil among two surfaces, which intersect a normal line of the first base face, of the first casing, and the front surface of the first casing is a surface positioned on a power transmission coil side from the first base face among the two surfaces, which intersect the normal line of the first base face, of the first casing may be used.

In addition, in the power transmission coil unit, a configuration in which an angle of an acute angle formed by the first face and the first base face is larger than an angle of an acute angle formed by the second face and the first base face may be used.

In addition, in the power transmission coil unit, a configuration in which a boundary between the first face and the second face is positioned nearer to the front surface of the first casing than to the rear surface of the first casing may be used.

In addition, in the power transmission coil unit, a configuration in which a housing part (in the example described above, the housing part BX3) that houses a foreign body in a case in which the foreign body falls from the first surface toward the rear surface side of the first casing is further included, and the housing part is disposed on the rear surface of the first casing may be used.

In addition, in the power transmission coil unit, a configuration in which the housing part includes a guide part (in the example described above, the guide part G1) that guides the foreign body to the housing part may be used.

In addition, in the power transmission coil unit, a configuration in which the first surface is made of a polyacetal resin or a nylon resin may be used.

Furthermore, there is provided a power receiving coil unit (in the example described above, the power receiving coil unit 21) includes: a power receiving coil (in the example described above, the power receiving coil L2); and a second casing (in the example described above, the power receiving-side casing BX2) housing the power receiving coil, wherein a second surface (in the example described above, the second surface SM2) of the second casing is a surface positioned on a predetermined second direction (in the example described above, a direction that is the same as the first direction) side among surfaces of the second casing and is inclined with respect to a second base face (in the example described above, the second base face LM2) of the second casing, wherein the second base face is a face that is parallel to a face having a largest area among faces facing the power receiving coil side of a base part of the second casing, and is a face that is parallel to the second direction, wherein the second surface is further inclined in a direction opposite to the second direction as the second surface becomes closer to a front surface of the second casing from a rear surface of the second casing, wherein the rear surface of the second casing is a surface that is positioned on a second base face side from the power receiving coil among two surfaces, which intersect a normal line of the second base face, of the second casing, and wherein the front surface of the second casing is a surface that is positioned on a power receiving coil side from the second base face among the two surfaces, which intersect the normal line of the second base face, of the second casing. In accordance with this, the power receiving coil unit can inhibit a foreign body that generates heats in accordance with a magnetic field from being placed on an upper face of the casing.

In addition, in the power receiving coil unit, a configuration in which the second casing includes a power receiving-side first member (in the example described above, the power receiving-side first member RB1) and a power receiving-side second member (in the example described above, the power receiving-side second member RB2), and the power receiving-side second member includes the base part of the second casing may be used.

In addition, in the power receiving coil unit, a configuration in which the power receiving-side first member and the power receiving-side second member are members that are separate from each other, the power receiving-side first member includes the second surface, and a value representing a surface roughness of the second surface is smaller than a value representing a surface roughness of a surface on the second direction side of the power receiving-side second member may be used

Furthermore, there is provided a power receiving coil unit includes: a power receiving coil; and a second casing including a power receiving-side main body member (in the example described above, the power receiving-side main body member MB2) that houses the power receiving coil and a power receiving-side inclination member (in the example described above, the power receiving-side third member RB3) that is attached to the power receiving-side main body member, wherein the power receiving-side inclination member includes a second surface of the second casing wherein the second surface is a surface positioned on a predetermined second direction side among surfaces of the second casing and is inclined with respect to a second base face of the second casing, wherein the second base face is a face that is parallel to a face having a largest area among faces facing the power receiving coil side of a base part of the second casing, and is a face that is parallel to the second direction, the second surface is inclined in a direction opposite to the second direction as the second surface becomes closer to a front surface of the second casing from a rear surface of the second casing, wherein the rear surface of the second casing is a surface that is positioned on a second base face side from the power receiving coil among two surfaces, which intersect a normal line of the second base face, of the second casing, and wherein the front surface of the second casing is a surface that is positioned on a power receiving coil side from the second base face among the two surfaces, which intersect the normal line of the second base face, of the second casing. In accordance with this, the power receiving coil unit can inhibit a foreign body that generates heats in accordance with a magnetic field from being placed on an upper face of the casing.

In addition, in the power receiving coil unit, a configuration in which an angle of an acute angle formed by the second surface and the second base face is equal to or larger than 5° may be used.

In addition, in the power receiving coil unit, a configuration in which the second surface is made of a polyacetal resin or a nylon resin may be used.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Wireless power transmission system
10 Wireless power transmission device
11 Power transmission unit
12 Power transmission coil unit
20 Wireless power receiving device
21 Power receiving coil unit
22 Power receiving unit
BX1 Power transmission-side casing
BX2 Power receiving-side casing
BX3 Housing part
G Ground surface
G1 Guide part
H1 Opening
L1 Power transmission coil
LM1 First base face
LM2 Second base face
L2 Power receiving coil
MB1 Power transmission-side main body member
MB2 Power receiving-side main body member
M1 First face
M2 Second face
RB1 Power receiving-side first member
RB2 Power receiving-side second member
RB3 Power receiving-side third member
SM1 First surface
SM2 Second surface
TB1 Power transmission-side first member
TB2 Power transmission-side second member
TB3 Power transmission-side third member
TC Three-dimensional coordinate system
θ, θ1, θ2 Angle

1. A power transmission coil unit comprising:
a power transmission coil; and
a first casing housing the power transmission coil,
wherein a first surface of the first casing is a surface positioned on a predetermined first direction side among surfaces of the first casing and is inclined with respect to a first base face of the first casing, and
wherein the first base face is a face that is parallel to a face having a largest area among faces facing the power transmission coil side of a base part of the first casing, and is a face that is parallel to the first direction.

2. The power transmission coil unit according to claim 1,
wherein the first casing includes a power transmission-side first member and a power transmission-side second member, and
wherein the power transmission-side second member includes the base part of the first casing.

3. The power transmission coil unit according to claim 2,
wherein the power transmission-side first member and the power transmission-side second member are members that are separate from each other,
wherein the power transmission-side first member includes the first surface, and
wherein a value representing a surface roughness of the first surface is smaller than a value representing a surface roughness of a surface on the first direction side of the power transmission-side second member.

4. A power transmission coil unit comprising:
a power transmission coil; and
a first casing including a power transmission-side main body member that houses the power transmission coil and a power transmission-side inclination member that is attached to the power transmission-side main body member,
wherein the power transmission-side inclination member includes a first surface of the first casing,
wherein the first surface is a surface positioned on a predetermined first direction side among surfaces of the first casing and is inclined with respect to a first base face of the first casing, and
wherein the first base face is a face that is parallel to a face having a largest area among faces facing the power transmission coil side of a base part of the first casing, and is a face that is parallel to the first direction.

5. The power transmission coil unit according to claim 1, wherein an angle of an acute angle formed by the first surface and the first base face is equal to or larger than 5°.

6. The power transmission coil unit according to claim 1,
wherein the first surface is inclined in a direction opposite to the first direction as the first surface becomes closer to a front surface of the first casing from a rear surface of the first casing,
wherein the rear surface of the first casing is a surface that is positioned on a first base face side from the power transmission coil among two surfaces, which intersect a normal line of the first base face, of the first casing, and
wherein the front surface of the first casing is a surface that is positioned on a power transmission coil side from the first base face among the two surfaces, which intersect the normal line of the first base face, of the first casing.

7. The power transmission coil unit according to claim 1,
wherein the first surface is inclined in a direction opposite to the first direction as the first surface becomes closer to a rear surface of the first casing from a front surface of the first casing,
wherein the rear surface of the first casing is a surface that is positioned on a first base face side from the power transmission coil among two surfaces, which intersect a normal line of the first base face, of the first casing, and
wherein the front surface of the first casing is a surface that is positioned on a power transmission coil side from the first base face among the two surfaces, which intersect the normal line of the first base face, of the first casing.

8. The power transmission coil unit according to claim 1,
wherein the first surface includes a first face and a second face that is positioned on a rear surface side of the first casing from the first face,
wherein the first face is inclined with respect to the first base face and is inclined in the first direction as the first face becomes closer to the rear surface of the first casing from the front surface of the first casing,
wherein the second face is inclined with respect to the first base face and is inclined in the first direction as the second face becomes closer to the front surface of the first casing from the rear surface of the first casing,
wherein the rear surface of the first casing is a surface positioned on a first base face side from the power transmission coil among two surfaces, which intersect a normal line of the first base face, of the first casing, and
wherein the front surface of the first casing is a surface positioned on a power transmission coil side from the first base face among the two surfaces, which intersect the normal line of the first base face, of the first casing.

9. The power transmission coil unit according to claim 8, wherein an angle of an acute angle formed by the first face and the first base face is larger than an angle of an acute angle formed by the second face and the first base face.

10. The power transmission coil unit according to claim 8, wherein a boundary between the first face and the second face is positioned nearer to the front surface of the first casing than to the rear surface of the first casing.

11. The power transmission coil unit according to claim 7, further comprising a housing part that houses a foreign body in a case in which the foreign body falls from the first surface toward the rear surface side of the first casing,
wherein the housing part is disposed on the rear surface of the first casing.

12. The power transmission coil unit according to claim 11, wherein the housing part includes a guide part that guides the foreign body to the housing part.

13. The power transmission coil unit according to claim 1, wherein the first surface is made of a polyacetal resin or a nylon resin.

14. A power receiving coil unit comprising:
a power receiving coil; and
a second casing housing the power receiving coil,
wherein a second surface of the second casing is a surface positioned on a predetermined second direction side among surfaces of the second casing and is inclined with respect to a second base face of the second casing,
wherein the second base face is a face that is parallel to a face having a largest area among faces facing the power receiving coil side of a base part of the second casing, and is a face that is parallel to the second direction,
wherein the second surface is further inclined in a direction opposite to the second direction as the second surface becomes closer to a front surface of the second casing from a rear surface of the second casing,
wherein the rear surface of the second casing is a surface that is positioned on a second base face side from the power receiving coil among two surfaces, which intersect a normal line of the second base face, of the second casing, and
wherein the front surface of the second casing is a surface that is positioned on a power receiving coil side from the second base face among the two surfaces, which intersect the normal line of the second base face, of the second casing.

15. The power receiving coil unit according to claim 14,
wherein the second casing includes a power receiving-side first member and a power receiving-side second member, and
wherein the power receiving-side second member includes the base part of the second casing.

16. The power receiving coil unit according to claim 15,
wherein the power receiving-side first member and the power receiving-side second member are members that are separate from each other,
wherein the power receiving-side first member includes the second surface, and
wherein a value representing a surface roughness of the second surface is smaller than a value representing a surface roughness of a surface on the second direction side of the power receiving-side second member.

17. A power receiving coil unit comprising:
a power receiving coil; and
a second casing including a power receiving-side main body member that houses the power receiving coil and a power receiving-side inclination member that is attached to the power receiving-side main body member,
wherein the power receiving-side inclination member includes a second surface of the second casing,
wherein the second surface is a surface positioned on a predetermined second direction side among surfaces of the second casing and is inclined with respect to a second base face of the second casing,
wherein the second base face is a face that is parallel to a face having a largest area among faces facing the power receiving coil side of a base part of the second casing, and is a face that is parallel to the second direction,
wherein the second surface is further inclined in a direction opposite to the second direction as the second surface becomes closer to a front surface of the second casing from a rear surface of the second casing,
wherein the rear surface of the second casing is a surface that is positioned on a second base face side from the power receiving coil among two surfaces, which intersect a normal line of the second base face, of the second casing, and
wherein the front surface of the second casing is a surface that is positioned on a power receiving coil side from the second base face among the two surfaces, which intersect the normal line of the second base face, of the second casing.

18. The power receiving coil unit according to claim 14, wherein an angle of an acute angle formed by the second surface and the second base face is equal to or larger than 5°.

19. The power receiving coil unit according to claim 14, wherein the second surface is made of a polyacetal resin or a nylon resin.

20. A wireless power transmission system comprising:
the power transmission coil unit according to claim 1; and
a power receiving coil unit.

21. A wireless power transmission system comprising:
the power receiving coil unit according to claim 14; and
a power transmission coil unit.

22. A wireless power transmission system comprising:
a power transmission coil unit including:
a power transmission coil; and
a first casing housing the power transmission coil, the first casing including:
a first surface positioned on a predetermined first direction side among surfaces of the first casing and being inclined with respect to a first base face of the first casing, and
the first base face is parallel to a face having a largest area among faces facing the power transmission coil side of a base part of the first casing, and being parallel to the first direction; and
the power receiving coil unit according to claim 14, wherein
the second direction is the same as the first direction.
